(19) United States
(12) Patent Application Publication
(10) Pub. No.: US 2010/0266835 A1
(43) Pub. Date: Oct. 21, 2010

(54) WALLBOARD TAPE

(76) Inventor: John S. Conboy, Chesterfield, MO (US)

Correspondence Address: EDWARD K. WELCH II;IP&L Solution, 4558 Ashton Court, Naples, FL, 34112, US

(21) Appl. No.: 12/772,151

(22) Filed: Apr. 30, 2010

Related U.S. Application Data
(63) Continuation-in-part of application No. 12/501,405, filed on Jul. 10, 2009.
(60) Provisional application No. 61/170,716, filed on Apr. 20, 2009.

(51) Int. Cl. B32B 5/18

(52) U.S. Cl. 428/306.6

(57) ABSTRACT

Wallboard tapes having flexibility and elasticity are provided comprising a nonwoven mat or from at least 50% to 90% rigid fibers and no more than 50% to 10% of flexible fibers. The preferred tapes are comprised of glass fiber as the rigid fiber and polyester fiber as the flexible fiber.

### RELATED APPLICATIONS

The present application is a Continuation-in-Part of pending U.S. patent application Ser. No. 12/501,405, filed Jul. 10, 2009, entitled Improved Wallboard Tape, which claims priority to U.S. Provisional Patent Application No. 61/170,716 filed Apr. 20, 2009, also entitled Improved Wallboard Tape, the contents of both of which are hereby incorporated herein by reference.

### FIELD OF THE INVENTION

The present invention relates generally to the field of wallboard tape.

### BACKGROUND OF THE INVENTION

Although widely used, especially by professional installers, paper wall board tapes have certain drawbacks. Specifically, a difficulty with paper tape is that it tends to absorb water and soften when applied over thick amounts of compound as is necessary when taping irregular joints and corners. When the paper softens it sags and deforms and a straight line corner is not achieved. Thus, paper must be applied over successively applied thin layers of compound which requires a number of coats of compound to build sufficient thickness. Fewer layers may be applied if one pre-fills any imperfections; however, this still does not address the issue with corners. In any event, each solution entails added labor costs and requires longer time for finishing since each layer of material must be sufficiently dried before the addition of the next layer.

Paper-based tapes also tend to absorb moisture and expand after application which can cause lifting, irregularities in the surface and cracking as the tape, which expands in water, shrinks as it dries out. Additionally, paper-based wallboard tape provides a growth medium for mold. Indoor mold growth is becoming an increasing concern as molds reduce interior air quality and in some cases can be toxic. However, thus far, no mold-resistant alternative to paper tape has been found which is capable of being produced as economically and cost effectively as paper tape.

While paperless wallboard tapes have been produced and are used commercially, they tend to be considerably thicker than paper tapes and much more expensive. These tapes are primarily made of glass fiber in a woven, and sometimes non-woven, construction. Fiberglass tapes are much more rigid than paper tapes and overcome the sagging and deformation issues of paper tape. However, because of their increased rigidity, there is a tendency for the tapes to break or crack when folded, especially when folded at right angles as needed for application to inside and outside corners. When this occurs, the tape must be removed and replaced, before the corner or angle is finished. These tapes also tend to be considerably thicker than paper tapes. While this makes for ease of use for the non-professional, for professional wallboard installers, the thicker tape can be more of a hindrance than a help as paper tape is. easily torn whereas fiberglass tapes must be cut. Also, because of the increased thickness, one must apply a greater flare-out of the mud to avoid the appearance of unevenness on the wall surface. Finally, since they tend to be thicker, when sanding a fiberglass tape joint to make a smooth surface, it is easier to sand into the tape, exposing the tape and its voids; thus, requiring additional repair. Thus, in addition to the higher costs of the fiberglass tapes, there is added expense in addressing repairs and the additional work necessitated by the wider flare-out.

Other advances have been made in wallboard tapes, including tapes of synthetic materials as films, perforated films, and woven and non-woven mats or sheets. The synthetic tapes have yet to achieve much commercial success due to the lack of sufficient strength and integrity in the tape. Additionally, these tapes tend to be quite flimsy, which makes them difficult to handle and apply.

More recently, Neill et. al. (U.S. 2008/0139064 A1) disclosed hybrid nonwoven joint tapes that do not swell substantially in the presence of water and are made of natural pulp, synthetic polymer fibers, glass fibers, or combinations thereof. Their teachings are sparse in terms of the tape and its construction; rather, Neill et. al. describe the properties they desire and. seemingly, leave it to the reader to figure out how to make it. The one example claims to be a ternary blend of glass fiber, polyester fiber and natural fiber, but there is no indication of its make-up or construction. Efforts to further define the tape were unsuccessful as it appears that the perhaps once commercial product is no longer listed on the supplier's website. Regardless, Neill et. al. make no critical assessment as to the components of the tape, allowing for a single matrix fiber or combinations of fibers: criticality seems to lie in the selection of fiber materials that do show water expansion. Based on the one example, and the disclosure, one would tend to be led to the use of ternary blends, including the presence of the natural fiber, as well as to such blends having a high content of synthetic polymer fibers.

Despite all the advances in the art, there is still a need for a seaming tape which is suitable for all applications, especially extreme and demanding applicatons such as inside and outside corners, sharp angles, and the like: applications where the seaming tapes are subject to significant bending during application.

Additionally, there is still a need for seaming tapes which not only avoid swelling and expansion in the presence of water, but which accommodate such swelling and expansion, without breaking or cracking. In particular, there is a continuing need for seaming tapes which will withstand the motion and forces of expansion and contraction in wallboard joints and seams, not just the tapes, associated with high humidity environments, seasonal changes, and/or exposure to water.

Furthermore, there is still a need for seaming tapes which are able to accommodate small movements in a wallboard. joint or seam without cracking or tearing of the tape, necessitating its replacement, where the movement is as a result of settling, swaying, shaking, or other movement of the building in which it is applied.

### SUMMARY OF THE INVENTION

The present invention provides for flexible wallboard tapes, often called seaming tapes, which allow for minor movement and/or expansion and/or contraction in a wallboard seam or joint without causing a tear or crack in the wallboard tape, regardless of whether such movement, expansion or contraction is due to ambient moisture, water exposure, or minor settling, movement or swaying of the structure in which it is installed. The flexible wallboard tapes generally comprise a mixture, as opposed to discrete layers, of rigid and flexible fibers. In particular, the present invention provides for wallboard tapes comprising a nonwoven mix of from about 50 to about 90%, preferably from more than 70% to about 85%, most preferably about 75%, by weight of a rigid fibrous material and from about 50 to about 10%, preferably less than 30% to about 15%, and most preferably about 25%, by weight of a non-rigid, flexible fiber. Most preferably, the nonwoven tape comprises a combination of glass fibers, as the rigid fibers, and polyester fibers, as the flexible fibers. The density of the non-woven tape is typically from about 8 to about 30, preferably from 12 to about 27, and most preferably from about 16 to about 22 pounds per thousand square feet of mat. The tapes may have an open or more closed pore or mesh structure, with less porosity being preferred so long as there is adequate interpenetration of the mud when applied.

Optionally, the tapes of the present invention may further comprise one or two layers of sequentially added adhesive and floc, the floc being of a synthetic or, preferably, natural fibrous material. Where a two or more layers are applied, it is preferred that the second or successive layer(s) is applied along the central axis of the wallboard tape so as to provide added height to the tape, which, when applied to angles and inside corners, provides added strength and contour to the corner, sometimes eliminating the need for applying the mud to the tape at the point where it bends.

### DESCRIPTION OF THE DRAWINGS

FIG. 1 is a plan view of the wallboard tape according to an embodiment of the present invention;

FIG. 2 is a plan view of the wallboard tape according to another embodiment of the present invention;

FIG. 3 is a plan view of the wallboard tape according to another embodiment of the present invention;

FIG. 4 illustrates a process of manufacturing wallboard tape according to an embodiment of the present invention; and

FIG. 5 is a plan view of the wallboard tape according to another embodiment of the present invention.

### DETAILED DESCRIPTION

As used herein and in the appended claims the term “non-woven” means a fabric-like material made from fibers and/or threads which are interlaid, but not in an identifiable manner as in a knitted or woven fabric, and bonded together. Nonwovens are typically manufactured by putting small fibers together in the form of a sheet or web, similar to paper, and then binding them either mechanically (e.g., by interlocking them with serrated needles such that the inter-fiber friction results in a stronger fabric), chemically (e.g., by use of a curable or settable adhesive or binder material), or thermally (e.g., by use of heat to fuse the fibers by causing one or more of the fibers and/or another heat sensitive material in the form of a fiber, powder, paste, or the like, which is integrated into or applied to the sheet or web, to melt or turn tacky, with or without pressure.

One class of non-wovens are the staple nonwovens which are made in a multi-step process wherein the fibers are first spun, cut to a few centimeters length, and put into bales which are then dispersed on a conveyor belt and the fibers spread in a uniform web by a wetlaid process or by carding. The fibers are then either thermally bonded or bonded by use of a binder or like resin. Bonding can be affected throughout the web by resin saturation or overall thermal bonding or in a distinct pattern via resin printing or thermal spot bonding.

Another suitable non-woven is that made by the melt blown process wherein polymer melt is extruded through a spin net or die to form long thin fibers which are stretched and cooled and which contact and bond to each other by passing hot air over the fibers as they fall from the die and onto a surface to form a web.

Finally, spun bond or spun laid nonwovens may also be used. These are made in a continuous process wherein the fibers are spun and then directly dispersed into a web by deflectors or can be directed with air streams. Again, the fibers bond to one another in their melt/tacky state.

The tapes according to the present invention are characterized as comprising a non-woven combination of rigid and flexible fibers which are randomly intermixed. In particular, the present invention provides for wallboard tapes comprising a nonwoven mix of from at least 50% to about 90%, preferably from more than 70% to about 85%, most preferably about 75% by weight of a rigid fibrous material, especially glass fiber, and from no more than 50% to about 10%, preferably less than 30% to about 15%, and most preferably about 25% by weight of a non-rigid, flexible fiber, especially polyester fiber. Although seaming tapes of higher rigid fiber content could be used, the higher rigidity will not avoid the problems of the fully glass fiber tapes. Similarly, while higher flexible fiber content could be used, the tapes become too flimsy and difficult to control during application. Additionally, one is still left with the problems of poor surface appearance of the angles and corners owing to the lack of structural integrity and shape maintenance in the tapes made entirely of or having a high content of flexible fibers.

As used herein the term “flexible fiber” refers to fibers that, when bent to form a 45° angle, preferably a 60° angle, most preferably a 90° angle or more, do not break or crack. In this respect, it is to be appreciated that a full break is not needed to make a joint or seam fail. Even a moderate degree of breakage of the fibers will cause the ends to protrude from the tape, especially the fold in the tape, making it difficult to properly finish the seam or joint and, consequently, produce a smooth finish on the painted wall. Most preferably, such flexible fibers also have an elongation which allows the fibers to stretch. In this respect, the degree of elongation of the fibers is preferably at least 0.1%, most preferably at least 0.2% up to 2% or even 4% or more, most preferably without yield. The combination of flexibility and elasticity without yield allows the tapes to “give” and retract as the joint expands and contracts with moisture and/or with settling, swaying or other motion, e.g. minor earthquakes, of the building in which it is installed.

The density of the non-woven tape is typically from about 8 to about 30, preferably from 12 to about 27, and most preferably from about 16 to about 22 pounds per thousand square feet of mat. The combination of density, strength and the overall nature of the construction of the present tapes enables thinner tapes than are achievable with glass fiber tapes. Specifically, the tapes of the present invention are generally of a thickness of from about 0.007 to about 0.050, preferably from about 0.010 to about 0.040, more preferably from about 0.015 to 0.020, inches and may be made in wide rolls that are subsequently slit to the desired width, generally 1⅞ to 2½, preferably from 2 to 2¼, inches wide, or the tapes may be made in the desired width directly. These tapes generally have a tensile strength (in the cross direction) of at least 15 pounds, preferably at least 20 pounds, more preferably at least 30 pounds, per inch of width.

The tapes of the present invention have an open pore system which allows for the penetration and flow of mud into and through the tape. While the size of the pores are such that they may be readily visible to the naked eye, they are preferably of a more narrow porous nature being minimally or non-visible to the naked eye. For example, the pores may be pinhole type pores or pores that are only visible under magnified examination. Furthermore, depending upon the thickness of the tape, the pores may be non-linear and form a more tortuous path through the tape. The key is that the tapes have pores of sufficient size and frequency to allow for the mud to penetrate into and preferably, through or nearly through the full thickness of the tape to provide added integrity and strength to the bond with the wallboard as well as cohesive strength within the seam. In the finished wallboard it is preferred that the mud fully penetrate through the full thickness of the tape.

The rigid fibers are selected from glass fiber, carbon fiber, graphite fibers, and rigid synthetic polymer fibers such as acrylic fibers and polystyrene fibers: most preferably the rigid fibers are glass fibers.

The flexible fibers are synthetic fibers having good flexibility such that a fabric comprised of the same will not break or crack when bent at an angle of 45° or greater, preferably 60° or greater, most preferably 90° or greater. Suitable flexible fibers are fibers prepared from polyester, including polyethylene terephthalate, polybutylene terephthalate, copolyethylene-butylene terephthalate, and copolyetheresters; polyolefins, including polyethylene, polypropylene and copolyethylene-propylene; nylon; polyacetate; polyvinyl acetate; rayon; polyvinylchloride, and copolymers and blends of the foregoing. Especially preferred are polyester, polyethylene, polypropylene, nylon, and combinations of any two or all three, particularly polyester fibers.

The non-woven tape may also comprise natural fiber as the flexible fiber or they may be used in combination therewith. Natural fibers include wood pulp fibers, including hardwood and softwood fibers; straw fibers; plant and grass pulp fibers; cotton fibers; other cellulosic fibers and the like. Despite the good flexibility of these fibers, their use in the tapes is not preferred owing to their tendency to absorb moisture and, especially in damp or humid environments, serve as a substrate for mold growth. Thus, if used, their use is minimal, perhaps a few percent by weight or so, in order to provide a more paper-like feel and behavior to the tapes. Most preferably, the tapes do not incorporate natural fibers.

Generally, the fibers to be used in the preparation of the nonwoven tape are chopped fibers or, in the case of melt blown or spun bonded nonwovens, a combination of chopped fibers, most notably the rigid fibers, especially glass fibers, and continuous lengths or threads of the flexible fiber. The chopped fibers, or short length fibers, will generally have lengths of from ¼″ to 1½″ or more, preferably from ⅜″ to 1⅛″, more preferably ½″ to 1″, even more preferably ⅝″ to ⅞″, and most preferably about ¾″ or will comprise mixtures of fibers within said ranges or any subcombination of thereof, especially combinations of upper and lower limit fiber lengths. It is believed that the shorter length fibers allow for more flexibility or expansion within the tape, especially if the nonwovens are held together by a flexible adhesive or binder material.

As noted above, the nonwoven tapes may be made by any of the known and traditional processes for their production except that an intimate mixture of the rigid and flexible fibers is used, especially in the wet laid process. However, since the non-synthetic, rigid fibers are not suitable for production/co-production in traditional spun bonded and melt blown processes, it is to be understood that, especially in those production processes not amendable to the melt extrusion or melt blown production of the rigid fibers chosen, e.g., glass fibers, carbon fibers, and graphite fibers, the rigid fibers will be introduced as chopped fibers as the fibers are being extruded or spun and/or as they molten fibers from the extrusion or spun bonding are laid upon the substrate. Here, the key is to ensure that the rigid fibers are integrated into the web of entangled fibers produced by the melt blown or spun bonding process. Preferably, the chopped rigid fiber is introduced into the dangling threads of the extrusion, in the case of the blown fibers, or into the fiber as it is being spun off the spinner, in the case of the spun bond fibers. For example, in a spun bonded process or blown fiber process, chopped glass fiber may be introduced to the chamber where the synthetic fiber is being spun or extruded, respectively, so that it becomes integrated into and entangled with the web formed by the spun bonding or melt blown process.

Finally, in those processes in which an adhesive or binder material is used, whether a film forming binder or a solid binder that forms a melt when heated to melt fuse the fibers, it is important to ensure that the binder does not fill all or substantially all of the pores or voids in the nonwoven matrix of the mat or sheet. Rather, as noted above, it is important that sufficient porosity remain to enable the mud to penetrate into the tape so as to enhance the cohesive and adhesive strength of the bond between the tape and the wallboard, consistent with industry standards. Suitable binders are well known and obvious to those skilled in the art.

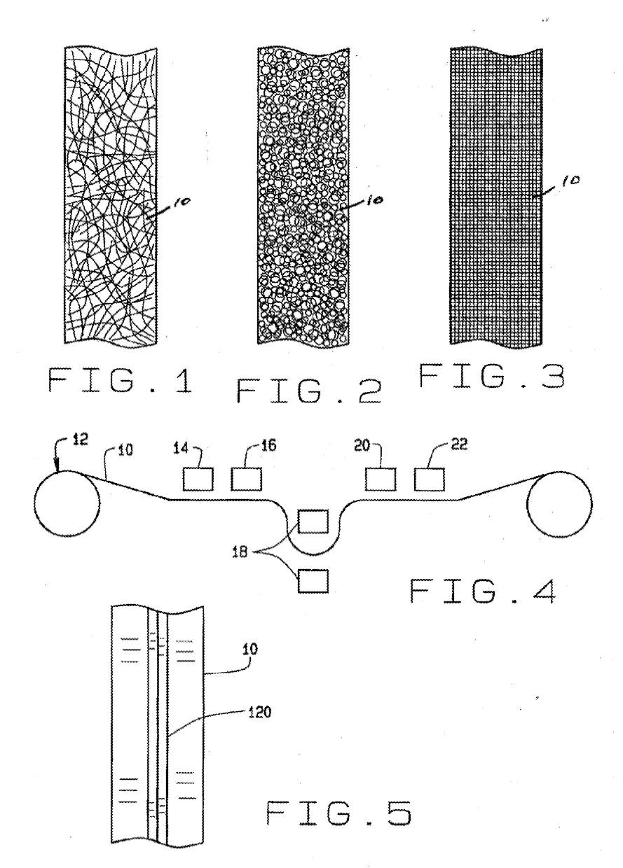

FIGS. 1 thru 3 show three different styles of tape. FIG. 1 shows as tape 10 in which the fibers may be laid down in a completely random fashion, which provides strength in multiple directions. Alternatively, the fibers may be laid in circular patterns as shown in FIG. 2, said configuration also providing strength in multiple directions. Alternatively, as shown in FIG. 3, the fibers may be laid in both horizontal and vertical directions to provide both lateral and longitudinal strength of the tape 10. Here strands formed of the mixture of fiber are formed and then laid across one another and, preferably, heat bonded to one another.

Optionally, though preferably, the tapes of the present invention may have one or more layers of floc applied to the exposed upper surface thereof, i.e., that surface facing away form the wallboard to which it is to be applied. The floc is preferably discrete fibers of nominal length, generally ¼ inch or less, preferably, 1/10 inch or less, more preferably 1/32 inch of less. Suitable floc materials include nylon, rayon, Dacron, polyester, cotton, other cellulosic fibers, combinations of any two or more of the foregoing, and the like. Especially preferred flocs are cotton fibers, nylon fibers and combinations thereof.

The floc is held onto the nonwoven tape by an adhesive which is applied to the tape as a liquid or tacky material before applying the floc. The floc will settle on and adhere to the wet or tacky adhesive material. That which does not, is then blown off to leave a thin layer of the floc on the nonwoven sheet or mat. The amount of floc to be applied is fairly minimal, just that amount necessary to provide a thin cover to the tape surface. The thickness of each coating of flocking is generally from about 0.002″ to about 0.0325″, preferably about 0.002″ to about 0.02″, more preferably about 0.002″ to about 0.01″ and most preferably about 0.006″.

As discussed above, the non-woven tape has pores where air and wallboard compound can pass between the fibers. When flocking is to be performed, it is important that the combination of the adhesive and flocking material not block or have at most a modest effect on the porosity of the underlying tape. While some blockage is to be expected, it is desired to minimize the extent thereof so that the pores, or a substantial portion thereof, remain open. As noted above, when the wallboard tape is applied to a base film of the wet wallboard compound, the wallboard compound enters these areas to firmly adhere the tape to the wall. Likewise, when the topcoat of compound is applied to the tape, the compound enters the open areas to further adhere the tape to the wall and the topcoat to the tape. The flocking material also assists in adherence of the compound to the tape and, therefore, the tape to the wall. Additionally, the flocking serves as a guide or indicator for the subsequent sanding process. In this respect when the workman is sanding the wallboard compound to smooth out the seam, as more and more wallboard compound is sanded off, tiny fibrils, representative of the floc, will become noticeable. At this point, the workman knows that he is approaching the tape and will discontinue sanding before impacting the tape and, potentially, necessitating its replacement. For example, continued sanding may tear the tape or cause large fibers to pull up from the surface of the tape causing “fluffing” which is difficult to paint over and/or created imperfections in the paint surface.

FIG. 4 shows one method for applying floc to the nonwoven sheet or mat. Specifically, a spool (12) of the nonwoven tape (10), which may be a stock roll that is to be slit to the desired width following flocking, is provided. As the tape is drawn off the spool it passes beneath coater 14 which applies the adhesive or binder to the upper surface of the tape (10). Many known methods may be used to apply the adhesive including roll coating, transfer printing, spraying, extrusion, and the like. To some extent, the method of application will depend upon the nature of the adhesive or binder to be used. For example, the adhesive or binder may be a curable material, a settable material, a solution based material, a hot melt, or the like.

After application of the adhesive, the tape is fed through a flocker 16 whereby a flocking material is applied to and distributed over the adhesive coated surface of the tape. As noted, the flocking material is preferably fibers of nylon, rayon, dacron, polyester, cotton or other cellulose, or other similar fibers or combinations of fibers. Thereafter the tape passes through a curing chamber (18) which may be an oven, a solvent evaporator, a cooler, or such other means that, depending upon the chemistry of the adhesive or binder, causes the same to cure or set, thereby securely holding the floc to the surface of the tape (10). For example, in the case of a heat cured or heat accelerated cured adhesive, the curing chamber will be an oven. For a solvent based adhesive in solution, the curing chamber may be a solvent evaporator which uses heat and/or vacuum to draw off the solvent. Or, in the case of a hot melt adhesive, the curing chamber may be a cooling unit which cools the temperature of the hot melt so that it firms up.

Preferably, the system further comprises one or more blowers (not shown), which may be positioned before or after the curing chamber, or both, which pass a stream of air across the tape to blow off excess floc and floc that has not been taken hold of by the adhesive or wet surface of the tape.

In the embodiment shown in FIG. 4, there is a second coater (20) and flocker (22) for applying a second layer of floc to the tape surface. Although not shown in FIG. 4, depending upon the nature of the binder or adhesive used in the second layer, there may be an additional curing chamber and/or blowers following the second coater and flocker. Finally, the coated tape is respooled at the opposite end of the system.

When a second layer of floc is applied, it may be applied to the entire width of the tape surface or is preferably applied to the center region of the tape or, in the case of tapes to be slit, the center regions of what will be the individual tapes. In the latter case, the band of the second adhesive and floc will generally be from about ½ to about ¾ inches wide and the thickness of the second layer in this central region will be sufficient to make a raised portion on the tape surface, preferably about 1/16^{th} of an inch or less. Where the second layer is applied to the central region of the tape, the added thickness provides improved rigidity and strength to the tape, factors that are especially of benefit should the tape be folded in the center as for interior or exterior wallboard corners. This is particularly useful when the tape is used for inside corner as the added bead of floc makes it unnecessary to apply wallboard compound all of the way into the corner or, if used, allows for the use of lesser amounts of wallboard compound. This simplifies the step of sanding the wallboard compound and avoids the need for the installer to perform appreciable sanding at the interior corner where sanding is difficult.

A further alternate embodiment of a tape according to the present invention is shown in FIG. 5. Here a stiffening strip (120) of a polyamid hot melt glue is applied to the center of the tape (10) to provide additional strength to the center portion of the tape. The strip of hot melt (120) is preferably about ¼ inch wide and about 0.030 inch thick. In this particular embodiment, the tape may also have a longitudinal rolled or embossed line 100 of weakness down the center thereof. The line of weakness facilitates folding the tape 10 along its central axis so as to make it easier for use on interior or exterior corner joints. It is to be appreciated that this line of weakness may be employed in all tapes according to the present invention, including those of just the rigid and flexible fibers and/or with or without one or more floc layers.

The tapes according to the present invention may also have length indicia printed on the edges at regular intervals (such as 6″ or 12″) to make cutting and installation of desired lengths very quick and easy. Knowing the length of the joint or seam to be covered, one can pre-cut the tapes to the desired length so that one does not have to worry about cutting while trying to apply the mud.

The preferred embodiment of the present invention comprises a tape comprised of a nonwoven mat of fiberglass and polyester fibers, with or without floc, but most preferably having a flocked surface of small fibers. The fiberglass fibers provide excellent tensile strength while the polyester fibers maintain flexibility of the tape. The use of such combinations of rigid and flexible fibers prevents, or certainly lessens, the likelihood of fiber breakage and protrusion from the tape, especially at the fold of the tape. Additionally, the tapes of the present invention are much more resistant to the formation of tears and/or cracks in the tape due to the shrinkage and/or expansion, especially cycles thereof, associated with the drying of the tape as well as subsequent water exposure and/or cycling between high and low humidity, as may occur with traditional paper tape. Finally, the construction and make-up of the present tapes also enables the tapes to resist tearing and/or cracking due to movement within or at the seam or joint as may be realized by settling, swaying, or other movement of the structure in which it is installed. Specifically, the mixture of fibers and the presence of the flexible fibers provide a degree of elongation to the tape so that it is able to accommodate the motion. Such is not possible with current, commercial tapes nor with developmental laminar tapes having a layer comprised of rigid materials, either film or fiber. Regardless, in each of these instances, should cracking be noted, it is typically limited to the wallboard compound on the tape which can readily be repaired by application of paint or, if wide and/or deep enough, by application of a thin layer of wallboard or spackling compound. In contrast, with prior art tapes, where actual tears or cracks appear in the tape, it is necessary to remove the tape and reapply.

When wallboard tape is typically applied to a wall, a thin film of wallboard compound is first applied to the wall and the tape applied to the thin film of wallboard compound to ‘seat’ the tape to the wallboard. Next, a thin film of wallboard compound is applied over the tape to cover the tape. After the compound has dried, it is sanded smooth and subsequent coats of drywall compound are applied and sanded as necessary to achieve a smooth joint.

Moreover, with the seaming tapes of the present invention, it is not possible for a drywall installer to wipe too much wallboard compound from the tape, as it will not “fluff up” to create fuzzy areas to which paint does not neatly adhere, as does paper tape. Additionally, wallboard tape of the present invention when installed in the same manner as paper tape oftentimes produces a joint that is 0.020″ thinner than using common paper based tape because compound comes through the tape, thereby making drywall butt joints easier to finish.

While preferred embodiments of the present invention have been disclosed and described in detail, and various alternate embodiments and elements have been described, it will be understood and appreciated by those skilled in the art that various changes and modifications can be made to the present invention without departing from the full spirit and scope of the invention. Thus, the scope of the invention should be determined by the appended claims and their equivalents, rather than by the specific examples and embodiments given.

I claim:

1. A wallboard tape comprising a nonwoven mat of a mixture of at least 50% to about 90% of one or more rigid fibers and no more than 50% to about 10% of one or more flexible fibers, provided that the flexible fiber is not a natural fiber, said non-woven mat having sufficient structural integrity and strength to be suitable for use as a wallboard seaming tape and having a porosity which allows for the interpenetration of a conventional mud.

2. The wallboard tape of claim 1 wherein the amount of rigid fiber is from more than 70% to about 85% by weight and the amount of flexible fiber is from less than 30% to about 15% by weight.

3. The wallboard tape of claim 1 wherein the rigid fiber is chopped glass fiber of from about ¼″ to 1½″ in length.

4. The wallboard tape of claim 1 wherein the flexible fiber is a synthetic polymer fiber whose polymer is selected from the group consisting of polyethylene, polypropylene, polyester and nylon,

5. The wallboard tape of claim 1 wherein the rigid fiber is chopped glass fiber and the flexible fiber is polyester.

6. A wallboard tape comprising a nonwoven mat of a mixture of more than 70% to about 90% of one or more rigid fibers and less than 30% to about 10% of one or more flexible fibers, said non-woven mat having sufficient structural integrity and strength to be suitable for use as a wallboard seaming tape and having a porosity which allows for the interpenetration of a conventional mud.

7. The wallboard tape of claim 6 wherein the rigid fiber is chopped glass fiber of from about ¼″ to 1½″ in length.

8. The wallboard tape of claim 6 wherein the flexible fiber is a synthetic polymer fiber whose polymer is selected from the group consisting of polyethylene, polypropylene, polyester, and nylon.

9. The wallboard tape of claim 6 wherein the rigid fiber is chopped glass fiber and the flexible fiber is polyester.

10. A wallboard tape comprising a nonwoven mat of a mixture of at least 50% to about 90% of one or more rigid fibers and no more than 50% to about 10% of one or more flexible fibers, and a top layer of a floc material bonded to the surface of said mat, said mat and said top layer having a porosity which allows for the interpenetration of a conventional mud.

11. The wallboard tape of claim 10 wherein the amount of rigid fiber is from more than 70% to about 85% by weight and the amount of flexible fiber is from less than 30% to about 15% by weight.

12. The wallboard tape of claim 10 wherein the rigid fiber is chopped glass fiber of from about ¼″ to 1½″ in length.

13. The wallboard tape of claim 10 wherein the flexible fiber is a synthetic polymer fiber whose polymer is selected from the group consisting of polyethylene, polypropylene, polyester, and nylon.

14. The wallboard tape of claim 10 wherein the rigid fiber is chopped glass fiber and the flexible fiber is polyester.

15. The wallboard tape of claim 10 wherein the floc is a fibrous material selected from the group consisting of nylon, rayon, dacron, polyester, cotton, and other cellulosic-type fibers.

16. The wallboard tape of claim 10 wherein the floc is a natural fiber material.

17. The wallboard tape of claim 10 wherein the top coat comprises two layers of floc material.

18. The wallboard tape of claim 17 wherein the second layer of floc material only covers the central area of the tape.

19. The wallboard tape of claim 10 having a weakness along its central axis such that the wallboard tape is easy to bend at its central axis.

20. The wallboard tape of claim 10 wherein a thin film of a hot melt adhesive is present along the central axis of the tape.
